(19) United States
(12) Patent Application Publication
(10) Pub. No.: US 2010/0072076 A1
(43) Pub. Date: Mar. 25, 2010

(54) SURFACE TREATMENT METHOD FOR HOUSINGS

(75) Inventors: FA-HONG ZENG, Shenzhen City (CN); XIAO-MING ZHU, Shenzhen City (CN); JIAN-BIN ZHAO, Shenzhen City (CN); HAI-TAO LUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/550,874

(22) Filed: Aug. 31, 2009

(30) Foreign Application Priority Data
Sep. 25, 2008 (CN) 200810304676.4

(51) Int. Cl. B23H 5/06; B44C 1/22

(52) U.S. Cl. 205/662; 216/108; 205/674

(57) ABSTRACT

A surface treatment method for housings, comprising: providing a substrate made of damascus steel; and chemically etching the substrate using inorganic acid solution or inorganic salts solution to give the substrate a patterned appearance.

### BACKGROUND

1. Technical Field

The present disclosure relates to a surface treatment method for housings.

2. Description of Related Art

Housings of portable electronic devices are commonly made of plastic or metal (such as aluminum, aluminum alloy, titanium, titanium alloy, magnesium and magnesium alloy, etc.). The housings are usually subjected to surface treatment to form colorful or protective coatings thereon. The surface treatment method may be electroplating, spray painting or electrophoretic deposition. These surface treatment processes are generally complicated and usually employ toxic electrolytes or paints. Furthermore, housings treated by these processes cannot present patterned appearances, such as floral prints.

Therefore, there is room for improvement within the art.

### DETAILED DESCRIPTION

A surface treatment method for housings may comprise the following steps: providing a substrate made of damascus steel; and chemical etching the substrate using inorganic acid solution or inorganic salts solution to give the substrate a flower patterned appearance. Each the step is disclosed in more detail below.

A substrate is provided. The substrate is made of damascus steel, for example, austenitic damascus steel. Damascus steel is known for its ability to present patterned appearance after being chemical etched under certain conditions. The substrate can be stamped to a housing.

The substrate is firstly electrochemical polished. The first electrochemical polishing step is carried out in an electrolyte applying a direct current, with the substrate being an anode, and a stainless steel cathode being provided and immersed in the electrolyte. The electrolyte may contain an ammonium sulfuric component in a mass percent of about 3-8%. The temperature of the electrolyte is about 90-100° C. The potential between the anode and the cathode is about 260-340V The electrochemical polishing process may last for about 60-120 seconds. The polishing step can improve the smoothness and gloss of the substrate greatly. After polishing, the substrate is washed by water and subjected to a neutralization treatment.

The substrate is mechanically polished. The surface of the substrate is now more smooth and glossy after the mechanical polishing.

The substrate is chemically etched using inorganic acid or inorganic salts to give it a patterned appearance, such as a floral pattern. The chemical etching step can be carried out using any of the follow processes alone or in combination (process 1-3):

In process 1, the substrate is immersed in a sulfuric acid solution and stirred for about 30-480 seconds. The percent of the sulfuric acid in the solution by volume is about 8-12%. The temperature of the solution is about 60-70° C. The sulfuric acid in the solution chemically reacts with the surface of the substrate during the etching step, which give the substrate a flower patterned appearance.

In process 2, the substrate is immersed in a solution containing nitric acid and hydrochloric acid and stirred for about 30-300 seconds. The mass percent of the nitric acid in the solution is about 10-12%, and the mass percent of the hydrochloric acid is about 5-6%. The temperature of the solution is about 20° C. The nitric acid and the hydrochloric acid in the solution chemically react with the surface of the substrate during the etching step, which give the substrate a flower patterned appearance.

In process 3, the substrate is immersed in a solution containing iron chloride and stirred for about 30-300 seconds. The mass percent of the iron chloride in the solution is about 0.7-1.0%. The solution may further contain hydrochloric acid and ethanol. The mass percent of the hydrochloric acid in the solution is about 5.2-6.7%, and the mass percent of the ethanol in the solution is about 36-38%. The temperature of the solution is about 20° C. The iron chloride and the hydrochloric acid in the solution chemically reacts with the surface of the substrate during the etching step, which give the substrate a flower patterned appearance.

The substrate undergoes a second electrochemical polishing step to remove the oxide impurity formed on the substrate during the chemical etching process. The second electrochemical polishing step may be the same to the first electrochemical polishing step. The second electrochemical polishing step may last for about 10-15 seconds. After the polishing, the substrate is again washed by water and subjected to a neutralization treatment.

A translucent metal coating is applied on one surface of the substrate. The method of forming the metal coating may be vacuum depositing. The metal coating can prevent the substrate from oxidation. The material of forming the metal coating may be titanium or chromium. The thickness of the metal coating is about 1-2 μm.

A protective coating is applied on the metal coating to prevent the metal coating from contamination. The protective coating may be formed by spraying or daubing fingerprint-proof agent(s) to the metal coating.

The present disclosure applies a chemical etching process onto a damascus steel substrate to make a housing having desired pattern, which can be easily implemented and more efficient. Furthermore, the chemical etching process is non-toxic.

It is believed that the present embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is

1. A surface treatment method for housings, comprising:
providing a substrate made of damascus steel; and
chemically etching the substrate using an inorganic acid solution to give the substrate a patterned appearance.

2. The method as claimed in claim 1, wherein the inorganic acid solution is sulfuric acid solution in a percent by volume of about 8-12%.

3. The method as claimed in claim 2, wherein the step of chemically etching the substrate in the sulfuric acid solution lasts for about 30-480 seconds at a temperature of about 60-70° C.

4. The method as claimed in claim 1, wherein the inorganic acid solution is a mixture solution of nitric acid in a mass percent of about 10-12% and hydrochloric acid in a mass percent of about 5-6%.

5. The method as claimed in claim 4, wherein the step of chemically etching the substrate in the mixture solution lasts for about 30-300 seconds.

6. The method as claimed in claim 1, wherein the substrate is made of austenitic damascus steel.

7. The method as claimed in claim 1, wherein prior to the chemically etching step, the substrate is firstly electrochemical polished in an electrolyte containing an ammonium sulfuric component in a mass percent of about 3-8% for about 60-120 seconds.

8. The method as claimed in claim 7, wherein the substrate is mechanically polished after the first electrochemical polishing process.

9. The method as claimed in claim 1, wherein after the chemically etching process, the substrate undergoes a second electrochemical polishing process in an electrolyte containing an ammonium sulfuric component in a mass percent of about 3-8%.

10. The method as claimed in claim 9, wherein after the second electrochemical polishing process, the substrate is applied with a translucent metal coating thereon by vacuum depositing.

11. The method as claimed in claim 10, wherein the metal coating is a titanium coating or a chromium coating having a thickness of about 1-2 μm.

12. A surface treatment method for housings, comprising:
providing a substrate made of damascus steel; and
chemically etching the substrate using inorganic salts solution to give the substrate a patterned appearance.

13. The method as claimed in claim 12, wherein the inorganic salts solution contains iron chloride in a mass percent of about 0.7-1.0%.

14. The method as claimed in claim 13, wherein the inorganic salts solution further contain hydrochloric acid in a mass percent of about 5.2-6.7% and ethanol in a mass percent of about 36-38%.

15. The method as claimed in claim 12, wherein the substrate is made of austenitic damascus steel.

16. The method as claimed in claim 12, wherein before the chemically etching step, the substrate is firstly electrochemical polished in an electrolyte containing an ammonium sulfuric component in a mass percent of about 3-8% for about 60-120 seconds.

17. The method as claimed in claim 16, wherein the substrate is mechanically polished after the first electrochemical polishing process.

18. The method as claimed in claim 12, wherein after the chemical etching process, the substrate undergoes a second electrochemical polishing process in an electrolyte containing an ammonium sulfuric component in a mass percent of about 3-8%.

19. The method as claimed in claim 18, wherein after the second electrochemical polishing process, the substrate is applied with a translucent metal coating thereon by vacuum depositing.

20. The method as claimed in claim 19, wherein the metal coating is a titanium or a chromium having a thickness of about 1-2 μm.
